(19) United States
(12) Patent Application Publication
(10) Pub. No.: US 2005/0137357 A1
(43) Pub. Date: Jun. 23, 2005

(54) Epoxy adhesive composition method of preparing and using

(76) Inventors: Michael J. Skoglund, Dublin, OH (US); Michael A. Abele, Columbus, OH (US)

Correspondence Address: ASHLAND INC., P.O. BOX 2219, COLUMBUS, OH, 43216, US

(21) Appl. No.: 10/941,694

(22) Filed: Sep. 15, 2004

Related U.S. Application Data
(60) Provisional application No. 60/530,764, filed on Dec. 18, 2003.

(51) Int. Cl. C08L 63/00

(52) U.S. Cl. 525/423

(57) ABSTRACT

The present invention relates to epoxy adhesive resins containing a curative comprising a polyamine, a polyamide, dicyandiamide and an imidazole. The adhesives are useful in structural applications for assembling parts for automobiles, aircraft, boats, refrigeration units, etc.

### BACKGROUND OF THE INVENTION

The present invention relates to epoxy adhesive compositions. More specifically, the invention relates to two component epoxy adhesives with a curative component comprising a polyamide, a polyamine, an imidazol and dicyandiamide. The compostions cure at ambient temperatures and are suitable for use as a structural adhesive.

Epoxy resins have been widely used in industrial assembly and transportation. Industrial epoxy adhesives are used to bond a variety of materials together such as metals, plastics, and composites. In assembly applications, the epoxy adhesives are typically cured in a heated fixture to accelerate bond strength development.

Dicyandiamide has long been known as a latent curative for epoxy resins. The systems are typically heat cured, (H. Lee and K. Neville “Epoxy Resins” McGraw Hill, New York, 1957, p 110). Dicyandiamide can be dispersed in an epoxy resin to provide a one component epoxy with a shelf life of at least 6 months. The latent nature of dicyandiamide depends on the fact that it is insoluble in the epoxy resin at ambient temperatures. Its cure properties appear to be related either to its dissociation products or to dissolution in the resin, which occurs at 145° -160° C., (C. May “Epoxy Resins” Second Edition, Marcel Dekker, New York, 1988, p 501).

Japanese patents (JP60069127 and JP61207425) disclose two component epoxies where the cure components contain a cyanguanidine, polyetherpolyamine, and a substituted urea or guanidine respectively. In JP60069127 a liquid, two part system was developed having a curative part comprised of dicyandiamide and a substituted urea purportedly dissolved in a polyetherpolyamine. In JP61207425 the curative part consisted of a cyanoguanide and a guanidine dispersed in a polyetherpolyamine. In each patent the epoxy resins are mixed with the curative component and cured at temperatures of 150° C.

EP 659833 discloses an epoxy resin composition comprising an epoxy resin and a hardener mixture consisting of dicyandiamide, a cycloaliphatic polyamine, a polyoxyalkylene amine and a cure accelerator. The cure accelerators disclosed are tertiary amines, quaternary ammonium compounds, and alkali metal alkoxides.

U.S. Pat. No. 4,859,761 teaches dicyandiamide is only soluble in solvents and discloses as an alternative the use of substituted cyanoguanidines as hardeners for epoxy resins. The disclosed substituted cyanoguanidines are said to be readily soluble in unproblematic solvents. Curing of the epoxy resin-substituted cyanoguanidine system is carried out at temperatures of from 100° C. to 300° C.

U.S. Pat. No. 5,214,098 discloses hardenable mixtures comprising an epoxy resin, a latent hardener which reacts only at temperatures of at least 80° C., an amine and a thiol. In addition the composition can optionally include an accelerator. A preferred latent hardener is dicyandiamide. The accelerator includes imidazole and substituted imidazoles. Although epoxy resins can be cured at room temperature, the rate of bond strength development is disadvantageously slow. Epoxy resin adhesives can be cured slowly with polyamides and polyamines at ambient temperature. Various cure accelerators or catalysts have been described for the systems cured with polyamides and polyamines. U.S. Pat. Nos. 4,668,736 and 5,629,380 disclose the use of metal salts in combination with a polyamide and a polyamine to accelerate cure.

The present invention is directed to the use of dicyandiamide and an imidazole in combination with a polyamide and polyamine as a curative system for curing epoxy resins at ambient temperature.

Ambient cure epoxy adhesive compositions of the invention are useful as structural adhesives for bonding metal to the same or different surfaces such as sheet molding compounds (SMC), fiber glass reinforced polyester (FRP), structural reaction injected molded (SRIM), resin transfer moldings (RTM) and the like. Structural adhesives are used by application of the adhesive to a surface of a part and positioning the surface of a second part over the adhesive covered surface of the first part. The process can be repeated as required.

### SUMMARY OF THE INVENTION

The present invention relates to ambient temperature curing epoxy adhesive compositions comprising the reaction product of a compound having an average epoxy functionality of at least two, dicyandiamide, an imidazole, a polyamide and a polyamine. In addition the epoxy adhesive composition further comprises toughening agents, adhesion promoters, particulate and reinforcing fillers, pigments, opacifiers, glass beads, microspheres and other conventional additives. In a preferred embodiment the composition of the present invention is used as an ambient temperature curable structural adhesive. The structural adhesive is useful in the automotive aftermarket, in panel bonding applications and multilayer laminates.

### DETAILED DESCRIPTION OF THE INVENTION

The present invention relates to ambient temperature curing of epoxy adhesive compositions. The ambient temperature being defined as from 20° C. to 60° C., preferably a range of from 20° C. to 30° C., more preferably from 20° C. to 26° C. Specifically, a structural adhesive capable of cure at ambient temperature within 4 hours where the cured adhesive has bond strengths, as measured by lap shear (ASTM D 1002-94 at 24° C.), of over 100 psi, and bond strengths of over 1000 psi after 24 hours. The epoxy resin adhesive compositions of the present invention comprises; a compound containing epoxy functionality, a polyamide, a polyamine, dicyandiamide (which is represented by the formula below), 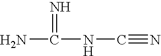
and an imidazol compound of the formula 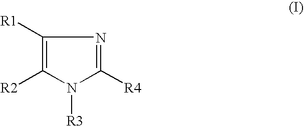
Where R1, R2, R3 and R4 are independently selected from H, CₙH₍₂ₙ₊₁₎, phenyl, hydroxy methyl, or ethyl triazine, and n=1 to 17.

The epoxy adhesive composition is formulated in two parts generally with the compound containing epoxy functionality in a first part and the curative comprising the polyamine, the polyamide, dicyandiamide and the imdazol compound in a second part. In alternate embodiments the dicyandiamide can be dispersed in the epoxy containing compound of the first part or divided between the first part and the second part.

In addition the epoxy adhesive composition can contain toughening agents, adhesion promoters, particulate and reinforcing fillers, pigments, opacifiers, glass beads, microspheres and other conventional additives known to be used in epoxy adhesives. It is preferred that there are no thiol group containing compounds present in the epoxy adhesive composition of the present invention. Compounds containing epoxy functionalities useful in the present invention include organic compounds having an average epoxy functionality of at least two. The epoxy compounds can be monomeric or polymeric, and aliphatic, cycloaliphatic, heterocyclic, aromatic or mixtures thereof. Examples of useful epoxy containing compounds includes polyglycidylethers of polyhydric alcohols such as ethylene glycol, triethylene glycol, 1,2-propylene glycol, 1,5-pentanediol, 1,2,6-hexanetriol, glycerol, 2,2-bis(4-hydroxy cyclohexyl) propane; polyglycidylethers of aliphatic and aromatic polycarboxylic acids, such as oxalic acid, succinic acid, glutaric acid, terephthalic acid, 2,6-naphthalene dicarboxylic acid and dimerized linoleic acid; polyglycidylethers of polyphenols, such as, bis-phenol A, bis-phenol F, 1,1-bis(4-hydroxyphenyl)ethane, 1,1-bis(4-hydroxyphenyl)butane and 1,5-dihydroxy naphthalene and mixtures thereof. Examples of commercially available epoxides useful in the invention include those available under the EPON trademark from Resolution such as EPON 828. A single compound or mixture of epoxy containing compounds can be used. The epoxy is preferably present in Part A in amounts of from about 30 to about 70 parts per hundred parts of Part A.

Polyamines used in the curative of the present invention include aliphatic polyamines, alicyclic polyamines, heterocyclic polyamines, aromatic polyamines, polyamines containing ether linkages in the backbone of the molecule and various mixtures thereof. Suitable polyamines include ethylenediamine, diethylenetriamine, pentaethylenehexylamine, polyetherdiamine, diethylaminopropylamine, triethenalamine, dimethyl aminomethylphenol, bis(aminopropyl)piperazine and mixtures thereof. Mannich bases and tertiary polyamines such as 2,4,6-tris(dimethylaminomethyl) phenol can also be used. Suitable polyamines are available commercially from Air Products and Chemical Co. under the Ancamine trademark and product designation Ancamine 1922, Ancamine 1922A which is a diaminopropyl diethylene glycol and Ancamine K-54 which is 2,4,6-tris(dimethylaminomethyl) phenol. A single polyamine or mixtures of polyamines can be used. Prefered amines comprise amines containing ether linkages in the backbone of the molecule such as diaminopropyl diethylene glycol and tertiary amines such as 2,4,6-tris(dimethylaminomethyl) phenol. The amine is preferably present in the curative (Part B) in amounts from about 5 to about 15 parts per hundred parts of Part B.

Polyamides suitable for use in the present invention include polyamide resins, polyaminopolyamides and polyamides that are the reaction product of diaminopropylether and a polycarboxylic acid. Suitable amides derived from the reaction product of the diaminopolyether and polycarboxylic acid are available commercially from Air Products and Chemical Company under the Ancamide trademark designation. A preferred amide is Ancamide 910 a condensation product of a dimer acid and diethylene glycol diaminopropyl ether. A single amide or mixture of amides can be used. Preferably, the amide is present in amounts from about 20 to about 60 parts per hundred parts of part B. Dicyandiamide is a necessary element of the present invention.

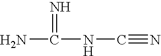

The dicyandiamide can be dispersed in the epoxy containing compound, added to the curative component or divided between the epoxy and the curative component. The dicyandiamide is present in amounts of about 1 to about 4 parts per hundred parts of Part B. Any amount of the dicyandiamide up to 4 parts per hundred can be dispersed in the epoxy of Part A instead of Part B.

Imidazoles of formula (I) are also used in the present invention. 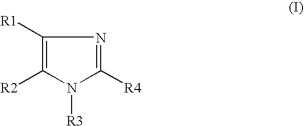
Where R1, R2, R3 and R4 are independently selected from H, CₙH₍₂ₙ₊₁₎, phenyl, hydroxy methyl, or ethyl triazine, and n=1 to 17. Examples of useful imidazoles include imidazole, 2-ethylimidazole, 2-ethyl, 4-methylimidazole, 2-phenylimidazole and the like. A single imidazole or mixture of imidazoles can be used. The imidazole is present in amounts of about 1 to about 6 parts per hundred parts of Part B.

Toughening agents commonly used with epoxy resins can be used in the present invention. Examples of suitable toughening agents include polymers having both a rubbery phase and a thermoplastic phase. Examples of such polymers include methacrylate/butadiene-styrene, acrylate/-methacrylate/butadiene-styrene and acrylonitrile/butadiene-styrene. An example of the foregoing is Paraloid EXL 2691 a methyl methacrylate butadiene-styrene impact modifier available from Rohm and Haas. Paraloid is a trademark of Rohm and Haas. Another example of toughening agents are rubber modified liquid epoxy resins. An example of such a resin is Kraton™ RP6565 Rubber available from Resolution. Another example of a class of tougheners includes epoxy rubber adducts. Such adducts include epoxy compounds reacted with liquid or solid butadiene-(meth)acrylonitrile copolymers having at least two groups that are reactive with epoxy groups, such as carboxyl, hydroxyl, mercapto, and the like. A further class of toughening agent includes rubbery copolymers such as amine terminated butadiene copolymers examples of which would include Hycar 1300X-16 a cyclic amine terminated acrylonitrile-butadiene rubber and Hycar 1300 X 42 a linear, aliphatic amine terminated acrylonitrile-buadiene rubber both of which are commercially available from Noveon. A single toughening agent or mixture of toughening agents can be used. Toughening agents can be added to either part A or part B of the epoxy adhesive composition.

The epoxy adhesive composition of the present invention can also include adhesion promoters known to be useful in formulating epoxy based adhesives. Such adhesion promoters include the reaction product of an omega-aminoalkyl trialkoxy silane with a glycidyl ether or polyglycidyl ether. Typical trialkoxy silane linkages include Si(OCH₃)₃ and —Si(OCH₂CH₃)₃ and are capable of hydrolyzing to Si(OH)₃. Suitable compounds include gamma-glycidoxypropyltrimethoxy silane, and beta-(3,4-epoxycyclohexyl) ethyltrimethoxy silane. In addition, organo-silanes containing moieties such as esters, vinyl, methacryloxy, amino, ureido, isocyanurate and isocyanate groups can be used. An example of a suitable amino silane is gamma-aminopropyltriethoxy silane A single adhesion promoter or mixture of promoters can be used.

Other optional ingredients in the epoxy adhesive composition include fillers examples of which include kaolin, talc, mica, calcium carbonate, fumed silica, glass and ceramic beads and microspheres both coated and uncoated, wollastonite, carbon fibers, textile fibers, wollastonite and the like. Other optional ingredients include pigments and opacifiers such as ferric oxide, carbon black and titanium dioxide. Any single optional ingredient or mixture of ingredients can be used as required.

The epoxy resin adhesive composition of the present invention can be prepared in any conventional manner known for preparing two part epoxy resin adhesive compositions. The components in each of the two parts are typically mixed by means of known mixing equipment such as high shear mixers and rollers. In the present invention it is preferred that the curative portion is prepared by first blending the polyamine and polyamide components and then heating the blend prior to adding the remaining components. After formulation, Parts A and B are mixed in predetermined ratios prior to application to a substrate. Parts A and B are typically mixed in a ratio by volume of from 1:1 to 10:1, preferrably 1:1 to 4:1 and most preferrably 1:1 to 2:1 of A:B.

The epoxy adhesive compositions of the present invention can be used for bonding metal to metal, metal to plastic and plastic to plastic. Examples of metals include steel cold rolled, galvanized seel, titanium, aluminum, magnesium and the like. Examples of plastic substrates includes polypropylene, polycarbonate, polyester, polyurethane, polyester, ABS and the like. The epoxy adhesive compositions can be used in assembling parts for automobiles, aircraft, boats, refrigeration units, etc.

The following examples are illustrative in nature and should not be construed as limiting.

Materials used in the Examples

10 mil glass beads

Cataphote mil spec No. 6

Ancamide 910

A polyamide made from tall oil fatty acid dimer and 3,3′-[oxybis(2,1-ethanediyloxy) ethanediyloxy) bis(1-propane] supplied by Air Products

Ancamine 1922

3,3′-[oxybis(2,1 -ethanediyloxy) bis(1 propane] supplied by Air Products

Ancamine K-54

2,4,6-tridimethylaminomethyl phenol supplied by Air Products

Cab-O-Sil TS-720

A treated amorphous fumed silica supplied by Cabot

Dicyandiamide

Amicure CG-1400 supplied by Air Products

Epon 828

Epoxy resin, diglycidyl ether of Bisphenol A supplied by Resolution

Fused Silica GP-71

A 10 micron silica glass supplied by Harbison Walker

Heloxy 107

Diglycidyl ether of cyclohexanedimethanol supplied by Resolution

Hycar 1300X-16

An amine terminated acrylonitrile butadiene rubber supplied by Noveon

Imidazol

Imicure Imidazol supplied by Air Products

Omicure 24EMI

2-Ethyl4-Methylimidazole supplied by CVC Specialty Chemical

Paraloid EXL 2691

Methyl methacrylate butadiene styrene impact modifier supplied by Rohm and Haas

Q-Cel 6042-S

A borosilicate coated glass microsphere supplied by Potter Industries Inc.

Scotchlite S-38

A 45 micron glass microsphere supplied by 3M

Silane A-187

gamma-Glycidoxypropyltrimethoxy silane supplied by GE Silicone-OSi Specialties

### EXAMPLE 1

### A Formulation of the Present Invention

Part A

| | |
|---|---|
| a) Epon 828 | 50.0 |
| b) Paraloid EXL 2691 | 7.0 |
| c) Heloxy 107 | 10.0 |
| d) Stantone 90EPX04 | 2.0 |
| e) Fused Silica GP-7I | 16.5 |
| f) Cab-O-Sil TS-720 | 2.0 |
| g) Silane A-187 | 2.0 |
| h) Potters Q-Cell 6042-S | 9.0 |
| i) 10 mil glass beads | 1.5 |

Part B

| | |
|---|---|
| a) Ancamide 910 | 42.0 |
| b) Ancamine 1922 A | 8.0 |
| c) Ancamine K-54 | 8.0 |
| d) Imicure Imidazol | 3.0 |
| e) Amicure CG 1400 | 2.5 |
| f) Hycar 1300 X-42 | 16.0 |
| g) Fused Silica GP-7I | 15.5 |
| h) Cab-O-Sil TS-720 | 5.0 |

### EXAMPLES 2-11

A series of two part formulations (Examples 2-11) were prepared as follows: The Part A's of the two part adhesive composition were prepared with high shear dispersing Paraloid EXL 2691 in Epon 828 at 80° C. for 150 minutes followed by the addition of Heloxy 107 and Silane A-187. This master batch was then divided. Each of the remaining components was separately added and mixed in a FlackTek DAC 400 FVZ SpeedMixer, 300 g capacity, for one minute at 2500 rpm, using a 8 oz polypropylene jar. The composition was cooled to 60° C. prior to adding the dicyandiamide when present in Part A.

The Part B's of the two part adhesive composition were prepared by blending the Ancamide 910, Ancamine 1922, and Ancamine K-54. This master batch was then divided into 4 oz polypropylene jars and heated in an oven to 60° C. Each of the remaining components was separately added and mixed in the SpeedMixer for one minute at 2500 rpm.

| | 2 | 3 | 4 | 5 | 6 | 7 | 8 | 9 | 10 | 11 |
|---|---|---|---|---|---|---|---|---|---|---|
| Part A (pph) | | | | | | | | | | |
| Epon 828 | 48.0 | 48.0 | 48.0 | 48.0 | 48.0 | 48.0 | 48.0 | 48.0 | 48.0 | 48.0 |
| Paraloid EXL 2691 | 7.0 | 7.0 | 7.0 | 7.0 | 7.0 | 7.0 | 7.0 | 7.0 | 7.0 | 7.0 |
| Heloxy 107 | 10.0 | 10.0 | 10.0 | 10.0 | 10.0 | 10.0 | 10.0 | 10.0 | 10.0 | 10.0 |
| Silane A-187 | 2.0 | 2.0 | 2.0 | 2.0 | 2.0 | 2.0 | 2.0 | 2.0 | 2.0 | 2.0 |
| Fused Silica GP-71 | 18.5 | 18.5 | 18.5 | 18.5 | 16.5 | 16.5 | 18.5 | 18.5 | 16.5 | 18.5 |
| Cab-O-Sil TS-720 | 2.0 | 2.0 | 2.0 | 2.0 | 2.0 | 2.0 | 2.0 | 2.0 | 2.0 | 2.0 |
| 10 mil glass beads | 1.5 | 1.5 | 1.5 | 1.5 | 1.5 | 1.5 | 1.5 | 1.5 | 1.5 | 1.5 |
| Scotchlite S-38 | 11.0 | 11.0 | 11.0 | 11.0 | 11.0 | 11.0 | 11.0 | 11.0 | 11.0 | 11.0 |
| Dicyandiamide | | | | | 2.0 | 2.0 | | | 2.0 | |
| Part B (pph) | | | | | | | | | | |
| Ancamide 910 | 42.0 | 42.0 | 42.0 | 42.0 | 42.0 | 42.0 | 42.0 | 42.0 | 42.0 | 42.0 |
| Ancamine 1922 | 8.0 | 8.0 | 8.0 | 8.0 | 8.0 | 8.0 | 8.0 | 8.0 | 8.0 | 8.0 |
| Ancamine K-54 | 8.0 | 8.0 | 8.0 | 8.0 | 8.0 | 8.0 | 8.0 | 8.0 | 8.0 | 8.0 |
| Hycar 1300X-16 | 16.0 | 16.0 | 16.0 | 16.0 | 16.0 | 16.0 | 16.0 | 16.0 | 16.0 | 16.0 |
| Imidazol | | 3.0 | | 3.0 | | 3.0 | | | | |
| Omicure 24EMI | | | | | | | 3.0 | 3.0 | 3.0 | |
| Dicyandiamide | | | 2.0 | 2.0 | | | | 2.0 | | |
| Fused Silica GP-7I | 22.0 | 19.0 | 20.0 | 17.0 | 22.0 | 19.0 | 19.0 | 17.0 | 19.0 | 22.0 |
| Cab-O-Sil TS 720 | 4.0 | 4.0 | 4.0 | 4.0 | 4.0 | 4.0 | 4.0 | 4.0 | 4.0 | 4.0 |

pph=parts per hundered

Two part dispensing cartridges with a 2:1 volume ratio and 50 ml total volume were filled. The Part A to B volume ratio was 2:1. The adhesives were dispensed through a six inch, ten element, static mixer.

Lap shear strength was tested according to ASTM D 1002-94 at 24° C. using an Instron tensile with a cross head speed of 0.5 in/min. Test specimens were prepared with 1″×4″×0.06″ unpolished cold rolled steel coupons that had been cleaned with methylethyl ketone toluene 1:1 solvent, abraded with a 80 grit disk on a random orbital sander, and cleaned again with the solvent. The overlap was 0.5″. The test specimens were clamped securely at 24° C., and adhesive.

Lap Shears (psi)

| Dwell Time | 2 | 3 | 4 | 5 | 6 | 7 | 8 | 9 | 10 | 11 |
|---|---|---|---|---|---|---|---|---|---|---|
| 4 hours | 2 | 8 | 130 | 190 | 26 | 293 | 19 | 498 | 108 | 2 |
| | 2 | 32 | 140 | 177 | 39 | 316 | 2 | 432 | 69 | 0 |
| | 2 | 79 | 150 | 147 | 21 | 214 | 34 | 440 | 74 | 2 |
| | 3 | 64 | 168 | 113 | 21 | 110 | 34 | 419 | 89 | 2 |
| | 2 | 42 | 110 | 150 | 39 | 163 | 42 | 362 | 69 | 0 |
| Average | 2 | 45 | 140 | 155 | 29 | 219 | 26 | 430 | 82 | 1 |
| Standard | 0 | 28 | 22 | 30 | 9 | 86 | 16 | 49 | 17 | 1 |
| Deviation | | | | | | | | | | |
| 14 hours | 1427 | 1749 | 1928 | 2014 | 2048 | 2052 | 1868 | 2392 | 226 | 2072 |
| | 1701 | 1696 | 2122 | 2024 | 2428 | 2380 | 1883 | 2428 | 2104 | 2072 |
| | 1781 | 1749 | 2228 | 2294 | 2610 | 2556 | 2026 | 2342 | 2134 | 1654 |
| | 1612 | 1735 | 2098 | 2550 | 2362 | 2262 | 1752 | 2226 | 1881 | 1949 |
| | 1561 | 1831 | 2096 | 2512 | 2256 | 2012 | 1891 | 2148 | 2158 | 2180 |
| Average | 1616 | 1752 | 2094 | 2279 | 2341 | 2252 | 1884 | 2307 | 2109 | 1985 |
| Standard | 135 | 49 | 108 | 257 | 208 | 227 | 97 | 117 | 141 | 202 |
| Deviation | | | | | | | | | | |
| 24 hours | 1827 | 2528 | 2260 | 2928 | 2706 | 2446 | 2444 | 2658 | 2488 | 1963 |
| | 2040 | 2558 | 2760 | 2988 | 2704 | 2994 | 2616 | 2798 | 2862 | 2250 |
| | 2372 | 2176 | 2762 | 3120 | 2958 | 3032 | 2278 | 2466 | 2590 | 2642 |
| | 2248 | 2296 | 2912 | 3254 | 2914 | 2959 | 2560 | 2340 | 2096 | 2396 |
| | 1604 | 1786 | 2278 | 3066 | 2708 | 2462 | 2260 | 2988 | 2708 | 2052 |
| Average | 2018 | 2269 | 2594 | 3071 | 2798 | 2778 | 2432 | 2650 | 2549 | 2261 |
| Standard | 311 | 314 | 303 | 126 | 127 | 297 | 161 | 258 | 289 | 272 |
| Deviation | | | | | | | | | | |

This data shows the most rapid development of lap shear strength is obtained with a combination of dicyandiamide and an imidazol.

Differential scanning calorimetry was conducted with a TA Instruments 2910 DSC using hermetic aluminum pans. The specimens of mixed adhesive were heated at a 10° C./min from 25° C. to 100° C.

Differential Scanning Calorimetry (DSC)

Extrapolated Onset of Exotherm (° C.)

| 2 | 3 | 4 | 5 | 6 | 7 | 8 | 9 | 10 | 11 |
|---|---|---|---|---|---|---|---|---|---|
| 50.0 | 44.3 | 36.7 | 37.0 | 40.8 | 35.3 | 44.0 | 24.8 | 32.1 | 29.2 |
| 40.9 | 46.1 | 35.3 | 35.2 | 35.9 | 37.3 | 43.3 | 26.8 | 33.7 | 42.7 |

1. A two part epoxy adhesive composition, comprising:
A) a compound having an average epoxy functionality of at least two, and
B) a curative comprising,
i. a polyamine,
ii. a polyamide,
iii. dicyandiamide, and
iv. an imidazole of the formula 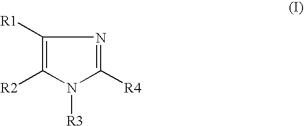
where R1, R2, R3 and R4 are independently selected from H, CₙH₍₂ₙ₊₁₎, phenyl, hydroxy methyl, or ethyl triazine, n=1 to 17 and the adhesive is cured at ambient temperature.

2. The composition of claim 1, wherein up to 100% of the dicyandiamide is dispersed in the compound containing at least one epoxy functional group.

3. The composition of claim 1, wherein the compound containing at least one epoxy functional group is selected from the group consisting of, polyglycidylethers of polyhydric alcohols, polyglycidylethers of aliphatic or aromatic polycarboxylic acids, polyglycidylethers of polyphenols and mixtures thereof.

4. The composition of claim 1, wherein the imidazole of formula (I) is selected from the group consisting of, imidazole, 2-ethylimidazole, 2-ethyl, 4-methylimidazole, 2-phenylimidazole and mixtures thereof.

5. The composition of claim 1, wherein the polyamine is selected from the group consisting of aliphatic polyamines, alicyclic polyamines, heterocyclic polyamines, aromatic polyamines, polyamine containing ether linkages in the backbone of the molecule and mixtures thereof.

6. The composition of claim 1, wherein the polyamine is a polyamine containing ether linkages in the backbone of the molecule.

7. The composition of claim 1, wherein the polyamide is selected from the group consisting of polyamide resins, polyamino polyamides, polyamides that are the reaction product of diaminopropyl ether and a carboxylic acid and mixtures thereof.

8. The composition of claim 1, further comprising a toughening agent.

9. The composition of claim 1, further comprising an adhesion promoter.

10. The composition of claim 1, further comprising microspheres.

11. The composition of claim 1, wherein A and B are mixed in a ratio by volume of from 1:1 to 10:1.

12. A laminate product, comprising; at least two sustrates wherein said substrates are adhesively joined with the ambient temperature cured residue of an adhesive, comprising;
A) a compound having an average epoxy functionality of at least two, and
B) a curative comprising,
i. a polyamine,
ii. a polyamide,
iii. dicyandiamide, and
iv. an imidazole of the formula 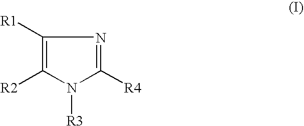
where R1, R2, R3 and R4 are independently selected from H, CₙH₍₂ₙ₊₁₎, phenyl, hydroxy methyl, or ethyl triazine, n=1 to 17.

13. The laminate of claim 12, wherein up to 100% of the dicyandiamide is dispersed in the compound containing at least one epoxy functional group.

14. The laminate of claim 12, wherein the compound containing at least one epoxy functional group is selected from the group consisting of, polyglycidylethers of polyhydric alcohols, polyglycidylethers of aliphatic or aromatic polycarboxylic acids, polyglycidylethers of polyphenols and mixtures thereof.

15. The laminate of claim 12, wherein the imidazole of formula (I) is selected from the group consisting of, imidazole, 2-ethylimidazole, 2-ethyl, 4-methylimidazole, 2-phenylimidazole and mixtures thereof.

16. The laminate of claim 12, wherein at least one substrate is metal.

17. The laminate of claim 12, wherein at least one substrate is a plastic.

18. The laminate of claim 12, wherein the adhesive further comprises a toughening agent.

19. The laminate of claim 12, wherein the adhesive further comprises an adhesion promoter.

20. The laminate of claim 12, wherein the adhesive further comprises microspheres.
